(19) United States
(12) Patent Application Publication
(10) Pub. No.: US 2016/0314359 A1
(43) Pub. Date: Oct. 27, 2016

(54) LANE DETECTION DEVICE AND METHOD THEREOF, AND LANE DISPLAY DEVICE AND METHOD THEREOF

(71) Applicant: HONDA MOTOR CO., LTD., Tokyo (JP)

(72) Inventor: Yosuke Sakamoto, Wako-shi (JP)

(73) Assignee: HONDA MOTOR CO., LTD., Tokyo (JP)

(21) Appl. No.: 15/133,622

(22) Filed: Apr. 20, 2016

(30) Foreign Application Priority Data
Apr. 21, 2015 (JP) 2015-086639

(51) Int. Cl. G06K 9/00; B60R 1/00

(52) U.S. Cl. CPC G06K 9/00798; B60R 1/00; B60R 2300/205; B60R 2300/308; B60R 2300/804

(57) ABSTRACT

A forward view image captured from a vehicle is divided into a plurality of blocks each continuous to each other in a vertical direction and extending in a horizontal direction, each of the blocks is determined as a bright block or a dark block, and a binarization threshold of the dark block is set to a binarization threshold smaller than a binarization threshold of the bright block.

### CROSS REFERENCES TO RELATED APPLICATIONS

The present application claims priority under 35 U.S.C. §119 to Japanese Patent Application No. 2015-086639, filed Apr. 21, 2015, entitled “Lane Detection Device and Method Thereof, and Lane Display Device and Method Thereof.” The contents of this application are incorporated herein by reference in their entirety.

### BACKGROUND

1. Field

The present application relates to a lane detection device and a method thereof that detect lane marks (indicating a lane boundary) formed on a road surface for vehicles, from a front image as seen from a vehicle captured by a vehicle-mounted image capturing device and that recognize a lane based on the detected lane marks, and also relates to a lane display device and a method thereof that display a display of the detected lane.

2. Description of the Related Art

As is known, lane marks that are formed on a road surface for vehicles are detected and recognized as follows: firstly, a brightness threshold used for the front image, captured by a vehicle-mounted camera and constituted of brightness signals, is set depending on a contrast between a lane mark brightness and a road surface brightness (lane mark brightness>road surface brightness); then binarization of the front image (brightness signals) is performed, by using the brightness threshold; and then edge detection is performed. With the detected lane marks based on the front image, a corresponding lane is recognized.

In this case, the brightness threshold used for the binarization to detect the lane marks is changed depending on ambient light, for example, based on a brightness histogram of the front image.

As an example, Japanese Unexamined Patent Application Publication No. 2007-257242 discloses a technique that detects and recognizes a white line by setting a binarization threshold of an image captured in a tunnel, in which headlights of running vehicles are turned on, as a threshold higher than a normal binarization threshold of an image captured under the sunlight (see paragraphs [0013] to [0015] and FIGS. 4 and 5 in Japanese Unexamined Patent Application Publication No. 2007-257242).

### SUMMARY

However, when a shadow of an object, such as a tall building, is across a part of a road surface under the sunlight, for example, the above technique disclosed in Japanese Unexamined Patent Application Publication No. 2007-257242 cannot detect lane marks which are under the shadow. This is because, regardless of the presence or absence of the shadow, the above technique applies the normal binarization threshold to a captured image although a certain portion of the image which is related to some lane marks has relatively low brightness signals.

In view of such a problem, the present application describes a lane detection device and a method thereof that can reliably detect and recognize lane marks even when a shadow is across a part of a road surface, and also describes a lane display device and a method thereof.

A lane detection device according to an aspect of the present application includes an image capturing device that captures an front or forward view image as seen from a vehicle and containing an image of a road surface, and a lane mark detection unit that performs binarization of the front image captured by the image capturing device, using a binarization threshold, and detects lane marks formed on the road surface. The lane mark detection unit divides the captured front image into a plurality of blocks each adjacent to each other in a vertical direction and extending in a horizontal direction, determines each of the plurality of blocks as a bright block having a relatively high brightness or a dark block having a relatively low brightness based on brightness of each of the divided blocks, changes the binarization threshold depending on whether the block is the bright block or the dark block, and performs binarization of the captured front image.

According to this aspect of the present application, the captured image is divided into the plurality of blocks each adjacent to each other in the vertical direction and extending in the horizontal direction, each of the blocks is determined as the bright block or the dark block, the binarization threshold is changed depending on whether the block is the bright block or the dark block, and the binarization of the captured front image is performed. Accordingly, this aspect can detect a lane mark which cannot be detected by a known technique which changes a fixed binarization threshold or a binarization threshold obtained from the brightness of the whole image.

For example, in the case of the dark block which contains a shadow of the overpass (bridge) or the like, crossing a part of the road surface, or which contains a shadow of a tall building, the binarization threshold of the dark block is changed into a binarization threshold that corresponds to the dark block. As a result, lane marks can be reliably detected even though the lane marks are contained in the dark blocks (most of pixels constituting the block are under the shadow), or are contained in the bright blocks (most of pixels constituting the block are not under the shadow).

To be more specific, the lane mark detection unit may divide the captured front image into the plurality of blocks each adjacent to each other in the vertical direction and extending in the horizontal direction, calculate a mean brightness for each of the blocks, determine each of the plurality of blocks as the bright block or the dark block based on the mean brightness of each of the blocks, set a binarization threshold of the dark block as a binarization threshold smaller than a binarization threshold of the bright block, and perform binarization of the captured front image.

According to this aspect of the present application, the captured front image is divided into the plurality of blocks each adjacent to each other in the vertical direction and extending in the horizontal direction, a mean brightness is calculated for each of the blocks (in units of blocks), each of the blocks is determined as the bright block or the dark block depending on the mean brightness for each of the blocks, the binarization threshold of the dark block is set as a binarization threshold smaller than the binarization threshold of the bright block, and binarization of the captured front image is performed. Accordingly, not only a lane mark in the bright portion in the front image but also a lane mark in the dark portion in the same front image which cannot be detected with a conventional technique can be detected.

Thus, the lane marks can be reliably detected even though the captured front image contains a shadow of the overpass (bridge) crossing a part of the road surface, or contains a shadow of a tall building, for example.

Preferably, the lane mark detection unit first divides the captured front image into the plurality of blocks each adjacent to each other in the vertical direction and extending in the horizontal direction, then further divides the blocks into left and right blocks, and then calculates a mean brightness for each of the resulting blocks.

When the sun is directly above a road, the bridge shadow is formed like a strip in a horizontal direction in the front image showing the road surface on which the lane marks are formed. But when the sun is either on the left-side or on the right side with respect to the road, the bridge shadow is often formed like a strip in a direction oblique to the horizontal direction. In the latter case, a mean brightness of a left block and a mean brightness of a right block in the front image become different to each other, which can cause a failure of detection of some lane marks.

For this reason, this aspect of the present application divides the captured front image into the plurality of blocks each adjacent to each other in the vertical direction and extending in the horizontal direction, then further divides the blocks into the left and right blocks, and then calculates a mean brightness for each of the resulting blocks. This allows the detection of a lane mark which cannot be detected with a conventional technique.

The mean brightness may be calculated sequentially from a lower side to an upper side of the plurality of blocks each extending in the horizontal direction. When the bridge shadow is formed in a strip in a horizontal direction and in a middle portion of the image, for example, the above calculation can determine the blocks in the order of the bright block, the dark block, and the bright block, from the lower side of the front image, which allows a stable lane mark detection.

Preferably, the binarization threshold is also set, in the order of the bright block, the dark block, and the bright block, from the lower side of the front image, as the binarization threshold of the bright block, the binarization threshold of the dark block smaller than the binarization threshold of the bright block, and the binarization threshold of the bright block. This allows easy and appropriate setting of the binarization thresholds of the bright block and the dark block.

Preferably, a display is further provided for indicating that lane marks are being detected by the lane mark detection unit when the lane mark detection unit is detecting the lane marks.

According to the aspect of the present application, the display for indicating that lane marks are being detected allows vehicle occupants to visually recognize a normal detection of the lane that is performed by the lane detection device.

The display, which may be a headup display, may show a lane-like display created to imitate lane marks. This allows a driver to recognize a normal detection of the lane, thus assisting driving.

A lane detection method according to an aspect of the present application performs binarization of an front image captured by an image capturing device that captures the front image as seen from a vehicle and containing an image of a road surface, using a binarization threshold, and detects and recognizes a lane. The method includes a block brightness calculation step that divides the front image into a plurality of blocks each adjacent to each other in a vertical direction and extending in a horizontal direction, and calculates a mean brightness for each of the blocks; a bright and dark blocks determination step that determines each of the plurality of blocks as a bright block or a dark block, based on the mean brightness of each of the blocks; a threshold determination step that determines a binarization threshold of the dark block as a binarization threshold smaller than a binarization threshold of the bright block; and a lane mark detection step that performs binarization of the captured front image by using the binarization threshold and detects lane marks.

According to this aspect of the present application, the captured image is divided into the plurality of blocks each adjacent to each other in the vertical direction and extending in the horizontal direction, a mean brightness is calculated for each of the blocks (in units of blocks), each of the blocks is determined as the bright block or the dark block depending on the mean brightness for each of the blocks, the binarization threshold of the dark block is set as a binarization threshold smaller than the binarization threshold of the bright block, and binarization of the captured front image is performed. Accordingly, not only a lane mark in the bright portion in the front image but also a lane mark in the dark portion in the same front image which cannot be detected with a conventional technique can be detected.

Thus, the lane marks can be reliably detected even though the captured front image contains a shadow of the overpass (bridge) crossing a part of the road surface, or contains a shadow of a tall building.

In this case, a display step may be further provided for displaying, on a front window of a vehicle, a lane-like display created to imitate lane marks detected by the lane detection method. This allows a driver to recognize a normal detection of the lane, thus assisting driving.

### BRIEF DESCRIPTION OF THE DRAWINGS

FIG. 1 is a block diagram of the schematic configuration of a vehicle having a lane detection device according to an embodiment of a device and a method of the present application.

FIG. 2 is a flowchart for illustrating the operation of the vehicle having the lane detection device.

FIG. 3 is a schematic diagram of a captured image stored in a memory.

FIG. 4 is a diagram for illustrating the captured image divided into 9 blocks.

FIG. 5A is a diagram for illustrating bright blocks and dark blocks of the image divided into 9 blocks.

FIG. 5B is a diagram for illustrating bright blocks and dark blocks of the image in which the blocks of FIG. 5A are further divided into left and right 18 blocks.

FIG. 6 is a diagram for illustrating lane marks detected using the divided 9 blocks.

FIG. 7 is a diagram for illustrating the captured image divided into 18 blocks.

FIG. 8 is a diagram for illustrating lane marks detected using the divided 18 blocks.

FIG. 9 is a diagram for illustrating a display on a headup display.

### DESCRIPTION OF THE PREFERRED EMBODIMENTS

With reference to the accompanying drawings, preferred embodiments of the present application will be described in detail below. The word “unit” used in this application may mean a physical part or component of computer hardware including a controller, a processor, a memory, etc., which is configured to perform intended functions, as disclosed herein.

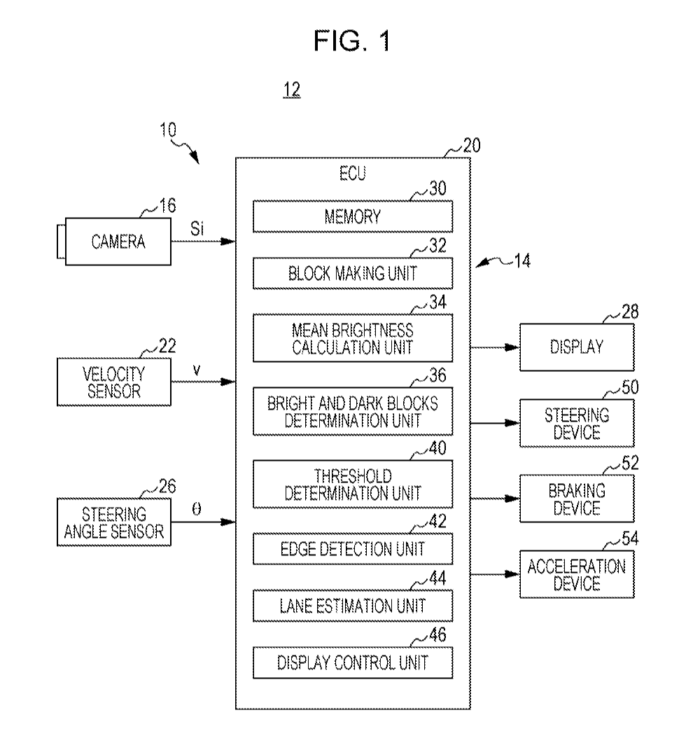

FIG. 1 is a block diagram of the schematic configuration of a vehicle 12 having a lane detection device 10 that achieves a lane detection device and a method thereof, and a lane display device and a method thereof according to the present embodiment.

The lane detection device 10 functions as a part of a drive assist device 14 mounted on the vehicle (referred to also as “own vehicle”) 12 for assisting steering operation with a steering wheel, braking operation with a brake pedal, and the like, which are performed by a driver of the vehicle 12 running along a lane boundary line (hereinafter referred to as “lane mark”) formed on a road.

The lane detection device 10 is applied to the drive assist device 14 in this embodiment, but it may also be applied to a device used for automatic driving.

The lane mark is used to indicate a lane boundary (lane section), and includes a continuous line (referred to also as “deemed continuous line”) constituted of broken white lines (line segments) spaced apart from each other, a continuous line such as a solid white line, and continuous marks (which may also be regarded as the deemed continuous line) constituted of Botts Dots, cat's eyes, or the like.

The lane detection device 10 of this embodiment essentially includes a camera (image capturing device) 16 for capturing a front image as seen from the vehicle 12, and an electronic control unit (ECU) 20 that detects lane marks based on the image captured by the camera 16 and recognizes a corresponding lane based on the detected lane marks.

The camera 16, which may be a video camera, is mounted on an upper portion of a front windshield of the vehicle 12, and is configured to capture a plurality of front images (multiple frames) as seen from the vehicle 12 per one second through the front windshield and to output a corresponding image signal (video signal) Si. The front images contain an image, of a road which is in front of the vehicle 12. In this case, the camera 16 has a real space coordinate system in which an origin O is defined as an attachment point of the camera 16, an X-axis is defined as a vehicle width direction (horizontal direction) of the vehicle 12, a Y-axis is defined as a vehicle axis direction (traveling direction, forward direction), and a Z-axis is defined as a vehicle height direction (perpendicular direction, vertical direction).

The drive assist device 14 includes not only the camera 16 and the ECU 20 but also a velocity sensor 22 used for detecting velocity v [m/s] of the vehicle 12, a steering angle sensor 26 used for detecting steering angle θ [deg] of a steering device 50 of the vehicle 12, a display 28, such as a headup display, for displaying vehicle information and the like (including velocity) on the front windshield, and the like.

The ECU 20 is a computer including a microcomputer, and has a central processing unit (CPU), memory elements such as a ROM (including an EEPROM) and a random access memory (RAM), input/output devices such as an A/D converter and a D/A converter, a timer for measuring time, and the like. The ECU 20 causes the CPU to read and execute a program stored in the ROM, and functions as a various-functions implementation unit.

In this embodiment, the ECU 20 functions as a block making unit 32 that divides a captured image into a plurality of blocks, a mean brightness calculation unit 34 that calculates a mean brightness for each of the divided blocks, a bright and dark blocks determination unit 36 that determines the blocks as a bright block or a dark block, a threshold determination unit 40 that determines binarization thresholds of the bright block and the dark block, an edge detection unit 42 that detects lane marks based on the captured image, a lane estimation unit 44 that estimates a lane based on the lane marks, a display control unit 46 that displays a display of the estimated lane on the display 28, and the like.

The drive assist device 14 includes the velocity sensor 22 and the steering angle sensor 26 in addition to the lane detection device 10 described above. The output from the steering angle sensor 26, which corresponds to the steering angle θ, is used to detect a traveling direction of the vehicle 12.

The drive assist device 14 assists driving performed by a driver, based on a lane recognized by the lane detection device 10. Specifically, the drive assist device 14 controls the steering device 50, the braking device 52, and the acceleration device 54 under a predetermined condition so that the vehicle 12 does not deviate from a road (that is, lane) defined by the lane marks formed on both sides of the road in a width direction of the vehicle 12, or so that the vehicle 12 can run on a general center of the lane. The predetermined condition includes a state in which a driver is holding a steering wheel (not shown). Further, the drive assist device 14 activates the braking device 52 and a reaction force applying mechanism (not shown) acting on an accelerator pedal, at a point before a curve of the road (that is, starting point of the curve).

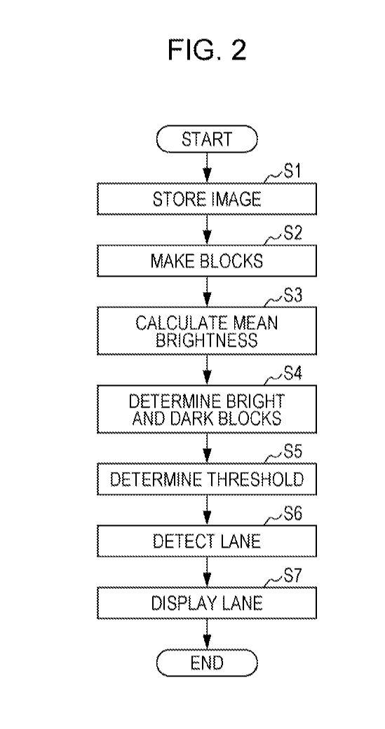

With reference to a flowchart of FIG. 2, the operation of the vehicle 12 that is basically configured in the above will be described. The program of the flowchart is executed by the ECU 20 (that is, CPU of the ECU 20). But, in the description herein, the ECU 20 is referred as necessary for clarifying the description.

In step S1, the ECU 20 causes a memory 30 to store a captured image (multi-valued grayscale image, or brightness signal) at intervals of predetermined frame time [s], that is, every time (frame) when a front image as seen from the vehicle 12 is captured by the camera 16 (front image capturing step).

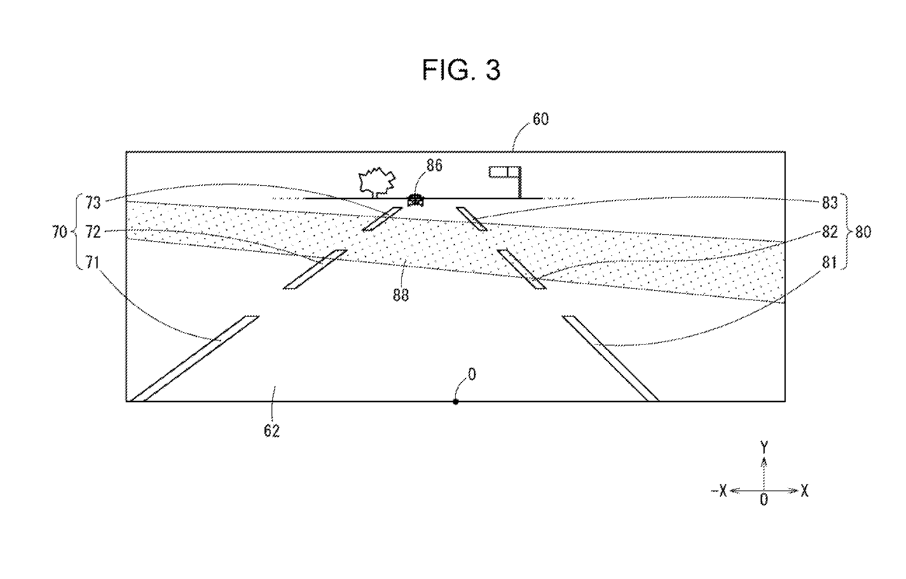

FIG. 3 shows an exemplary image (grayscale image) 60 stored in the memory 30 as digital data. The image 60 shows a road surface (road) 62, a left lane mark 70 and a right lane mark 80 formed on the road surface 62 on the left side and the right side with respect to the origin O of the vehicle 12 (that is, attachment position of the camera 16), a preceding vehicle 86, and the like.

The left lane mark 70 includes lane marks 71, 72, and 73 extending from the left side of a lower portion of the image 60 (located at the position of the vehicle 12) to the center of an upper portion of the image 60 (located in a forward direction extending far from the vehicle 12), and the right lane mark 80 includes lane marks 81, 82, and 83 extending from the right side of the lower portion of the image 60 (located at the position of the vehicle 12) to the center of the upper portion of the image 60 (located in a forward direction extending far from the vehicle 12).

The image 60 also shows a shadow 88 of a bridge (hereinafter the shadow is referred to as “bridge shadow”, and the bridge is referred to as “overpass”). The bridge shadow 88 crosses the road and has a constant width, lying on the lane marks 72, 73, 82, and 83 of the lane marks 70 and 80.

In step S2, the block making unit 32 divides the captured image 60 into blocks (sections) (former part of block brightness calculation step).

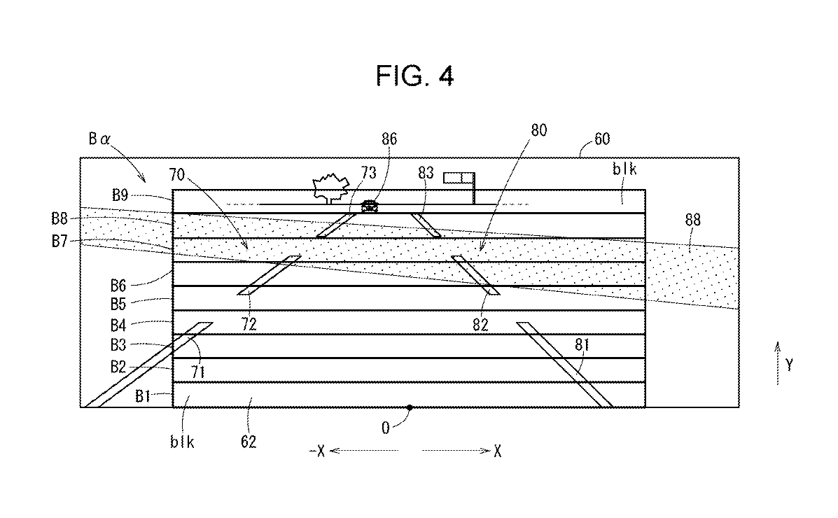

FIG. 4 shows the image 60 that includes the lane marks 70 and 80 and the road surface 62 for the vehicle 12, and that is divided into 9 blocks blk (blocks B1 to B9) each adjacent to each other in a vertical direction (Y direction) and extending in a horizontal direction (X and −X direction). The 9 blocks constitute a block Bα. The number of the blocks B1 to B9 each adjacent to each other in the vertical direction is not limited to nine, and may be any number selected depending on the performance of the camera 16 and the ECU 20.

In step S3, the mean brightness calculation unit 34 calculates a mean brightness of pixels constituting each of the blocks blk. Specifically, the mean brightness calculation unit 34 calculates the mean brightness Bmean of each of the blocks folk (that is, each of S blocks B1 to B9) by summing brightness values of pixels constituting each of the blocks blk and then dividing the summed brightness value by the number of pixels (latter half of block brightness calculation step). The mean brightness Bmean of each of the blocks blk decreases as each of the blocks blk has a greater portion of the bridge shadow 88.

In step S4, the bright and dark blocks determination unit 36 compares the mean brightness Bmean of each of the blocks blk with a threshold Th predetermined through an experiment or a simulation. If Bmean>Th holds, then the bright and dark blocks determination unit 36 determines the block as a bright block blkw. If Bmean<Th holds, then the bright and dark blocks determination unit 36 determines the block as a dark block blkb (bright and dark blocks determination step). Preferably, this determination is performed from the lower side of the image 60 (near the vehicle 12) to the upper side of the image 60 (far from the vehicle 12) in the order of block B1, B2, . . . , B9. With this order of determination, a mean brightness Bmean of a block blk having no shadow and a normal brightness in the image is calculated first. This facilitates recognition of a shadow when the shadow is lying on an upper block of the blocks blk, and allows a normal processing on the other blocks blk which have no shadow.

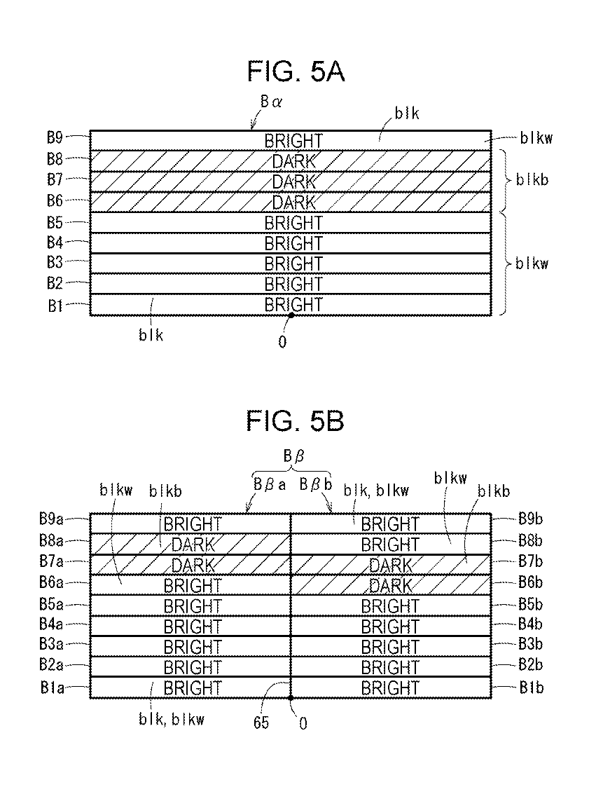

As shown in FIG. 5A, blocks B1 to B5 of the image 60 that shows the bridge shadow 88 in FIG. 4 are firstly determined as bright blocks blkw sequentially from the lower side of the image 60 in step S4, then hatched blocks B6 to B8 are determined as dark blocks blkb, and then block B9 is determined as the bright block blkw again.

In step S5, the threshold determination unit 40 determines a binarization threshold Thw of the bright block blkw as the binarization threshold Th (which is the normal threshold and is referred to also as “bright portion threshold Thw”; Th=Thw) predetermined through the experiment or the simulation, and also determines a binarization threshold Thb of the dark block blkb (which is referred to as “dark portion threshold Thb”; Th=Thb) as the binarization threshold Thb predetermined through an experiment or a simulation and smaller than the bright portion threshold Thw (Thb<Thw) (threshold determination step).

In step S6, binarization is performed for each pixel in the horizontal row of the image 60, by comparing a pixel value of each pixel of each of the blocks blk with the binarization threshold (bright portion threshold Thw if the block is the bright block blkw, or dark portion threshold Thb if the block is the dark block blkb). In this case, if the pixel value of each pixel of the bright block blkw is greater than the bright portion threshold Thw, then 1: detection is determined, and if the pixel value of each pixel of the bright block blkw is smaller than the bright portion threshold Thw, then 0: no detection is determined; if the pixel value of each pixel of the dark block blkb is greater than the dark portion threshold Thb, then 1: detection is determined, and if the pixel value of each pixel of the dark block blkb is smaller than the dark portion threshold Thb, then 0: no detection is determined (lane mark detection step).

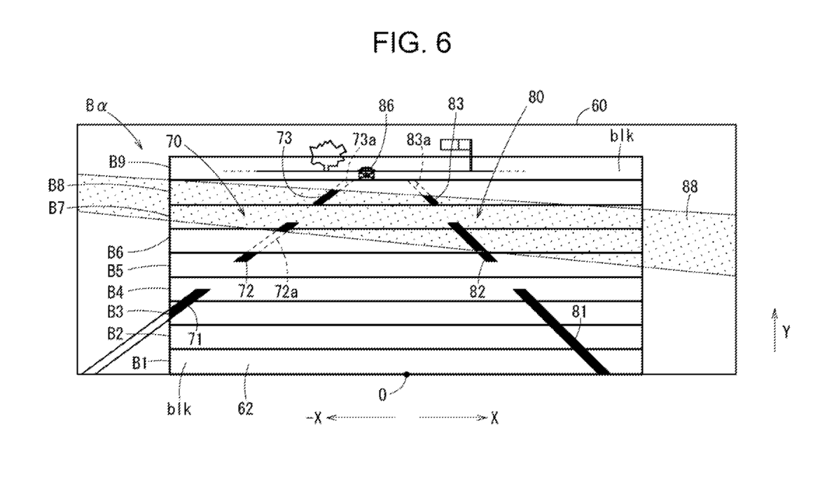

FIG. 6 shows lane mark candidates detected through the lane-detection binarization performed in step S6, by filling the candidates with black. The portions, filled with black, of the lane marks 71, 72, 73, 81, 82, and 83 can be extracted as the lane mark candidates.

As can be seen, the dark portion threshold Thb used for the binarization of the dark block blkb, which is smaller than the bright portion threshold Thw used for the binarization of the bright block blkw, makes it possible to detect portions of the lane marks 72, 73, 82, and 83, which cannot be detected with a conventional technique and which are contained in the dark blocks blkb and are under the bridge shadow 88 (in FIG. 6, the above portions are more than half of the lane marks 72, 73, 82, and 83).

However, this process disadvantageously fails to detect relatively long lane marks 72a and 83a (FIG. 6) of the lane marks 72 and 83 illustrated with broken lines, which would be able to be detected with a conventional technique.

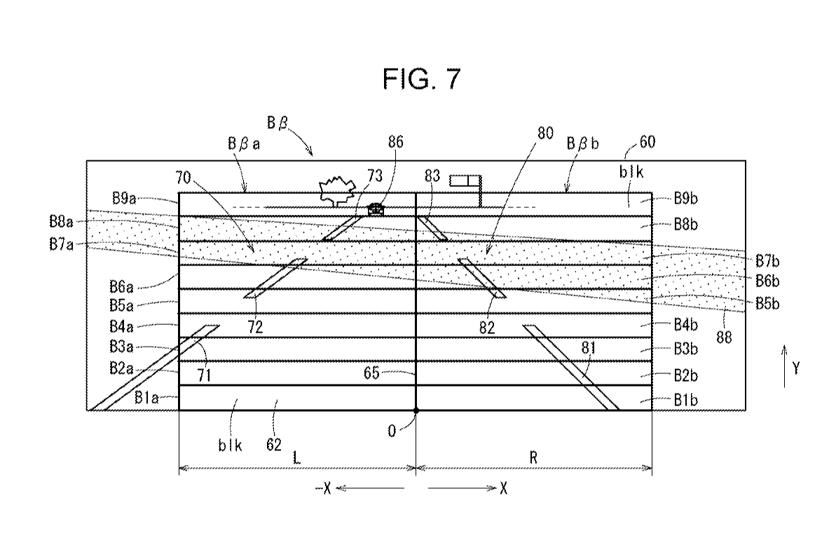

As a countermeasure of this, the image 60 is further divided into left and right 18 blocks (blocks B1a to B9a, blocks B1b to B9b) by using a center line 65, as shown in FIG. 7, for example (block making: step S2). In FIG. 7, a block Bβa (blocks B1a to B9a) and a block Bβb (blocks B1b to B9b) constitute a block Bβ. Then, a mean brightness of each of the divided 18 blocks blk is calculated (step S3), and the blocks are determined as a bright block or a dark block again (step S4). In this way, the bright and dark blocks as indicated in FIG. 5B are obtained.

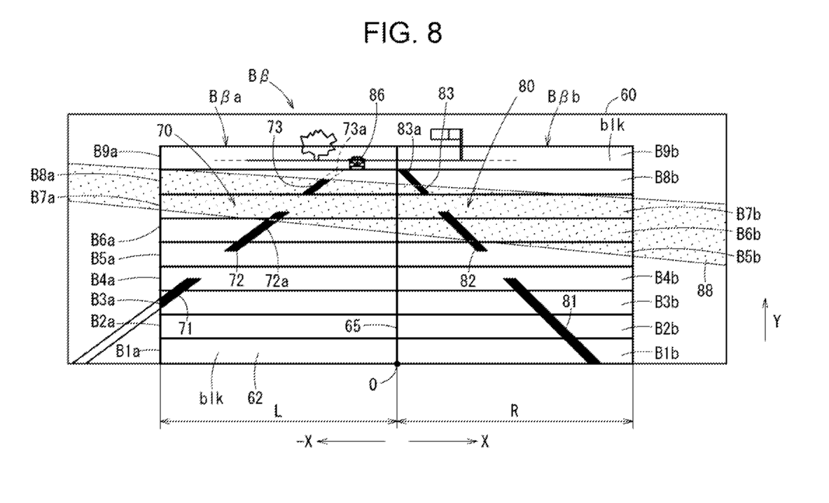

In the same manner as in step S5 described above, the thresholds (bright portion threshold Thw and dark portion threshold Thb, Thb<Thw) are then determined. In step S6, binarization is performed for each of the divided blocks blk. With these processes, it becomes possible to detect the relatively long lane marks 72a and 83a of the lane marks 72 and 83 illustrated with broken lines (FIG. 6), as shown in FIG. 8.

After the detection of lane mark candidates, the edge detection unit 42 differentiates the detected (extracted) lane mark candidates (here, detected signal of the lane mark candidates is like a rectangular wave in a horizontal direction) to detect rising and falling edges, in step S6, as is known. The lane estimation unit 44 then determines lane mark candidates which have a width between the rising and falling edges near a width of the actual lane marks, as the lane marks 71, 72, 73, 81, 82, and 83. After this, the lane estimation unit (lane recognition unit) 44 per-forms projective transformation of the determined lane marks 71, 72, 73, 81, 82, and 83 into a bird's eye view, then performs curve approximation of the bird's eye view using the least squares method that uses a quadratic curve, a clothoid curve, or the like, and then detects (recognizes) an approximate straight line and curve as a corresponding lane. When it is known on map data or the like that the road surface (road) 62 is straight, straight-line approximation may be performed.

With this, the drive assist device 14 controls the steering device 50, the braking device 52, the acceleration device 54, and the like so that the vehicle 12 does not deviate from a lane, or so that the vehicle 12 can run on a center of a straight and curved lane, along the detected (recognized) lane, thereby assisting driving performed by a driver.

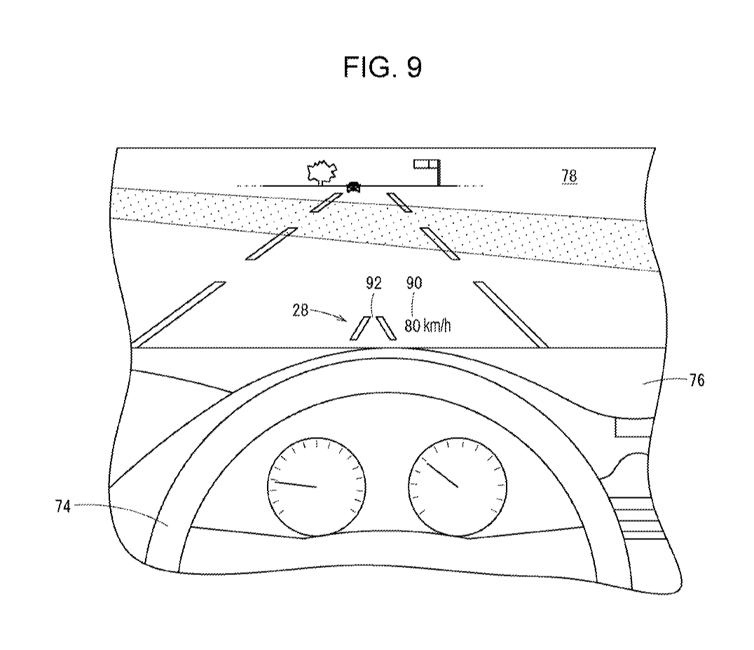

In step S7, as shown in FIG. 9, the display control unit 46 causes the display 28 to show a display 90 (80 km/h) which indicates the velocity v being detected by the velocity sensor 22. The display 28 (headup display) is in front of the dashboard 76 and on the front windshield 78. Further, the display control unit 46 causes the display 28 to show a lane-like display 32 created to imitate lane marks, which indicates that the lane is normally being detected (display step), and thereby can inform a driver (not shown) steering a steering wheel 74 that the lane is normally being detected.

With a vehicle having no headup display, the lane-like display 92 may be displayed, for example, on a multi-information display.

[Main Points of Embodiments]

As described in the above, the lane detection device 10 of the above-mentioned embodiments includes the camera 16 (image capturing device) for capturing the front image as seen from the vehicle 12 and containing an image of the road surface 62, and the ECU 20 serving as the lane mark detection unit that performs binarization of the image 60 (FIG. 3) captured by the camera 16, using the binarization threshold, to detect the lane marks 70 (71, 72, 73) and 80 (81, 82, 83) formed on the road surface 62.

In this case, the ECU 20 that serves as the lane mark detection unit divides the captured image 60 into a plurality of blocks blk each adjacent to each other in a vertical direction and extending in a horizontal direction, determines each of the plurality of blocks as a bright block blkw (FIG. 5A and so forth) having a relatively high brightness or a dark block blkb having a relatively low brightness based on brightness of each of the divided blocks blk, changes the binarization threshold Th depending on whether the block is the bright block blkw or the dark block blkb, and performs binarization of the captured image 60.

In this embodiment, the captured image 60 is divided into the plurality of blocks B1 to B9 each adjacent to each other in the vertical direction and extending in the horizontal direction, each of the blocks B1 to B9 is determined as the bright block blkw or the dark block blkb, the binarization threshold Th is changed depending on whether the block is the bright block blkw or the dark block blkb, and binarization of the captured image 60 is performed. Accordingly, this embodiment can detect a lane mark, such as the lane mark 82, which cannot be detected by a known technique which changes a fixed binarization threshold or a binarization threshold obtained from the brightness of the whole image 60.

For example, in the case of a dark block blkb which contains the bridge shadow 88 of the overpass (bridge) or the like, crossing a part of the road surface 62, or which contains a shadow of a tall building, the binarization threshold of the dark block blkb is changed into a binarization threshold Thb that corresponds to the dark block blkb. As a result, lane marks can be reliably detected even though the lane marks are the lane marks 72, 73, 82, and 83 contained in the dark blocks blkb (most of pixels constituting the block are under the shadow), or are the lane marks 71, 81, and the like contained in the bright blocks blkw (most of pixels constituting the block are not under the shadow).

Preferably, the ECO 20 that serves as the lane mark detection unit divides the captured image 60 into the plurality of blocks B1 to B9 (FIG. 4) each adjacent to each other in the vertical direction and extending in the horizontal direction, calculates a mean brightness Bmean for each of the blocks B1 to B9, determines each of the plurality of blocks blk as a bright block blkw or a dark block blkb based on the mean brightness Bmean of each of the blocks blk, sets the binarization threshold Thb of the dark block blkb as a binarization threshold smaller than the binarization threshold Thw of the bright block blkw (Thb<Thw), and performs binarization of the captured image 60.

With this configuration, the captured image 60 is divided into the plurality of blocks B1 to B9 each adjacent to each other in the vertical direction and extending in the horizontal direction, the mean brightness Bmean is calculated for each of the blocks blk (in units of blocks), each of the blocks blk is determined as the bright block blkw or the dark block blkb depending on the mean brightness Bmean for each of the blocks blk, the binarization threshold Thb of the dark block blkb is set as a binarization threshold smaller than the binarization threshold Thw of the bright block blkw (Thb<Thw), and binarization of the captured image 60 is performed. Accordingly, not only a lane mark in the bright portion in the image 60, such as the lane mark 81, but also a lane mark in the dark portion in the image 60, such as the lane mark 82, which cannot be detected with a conventional technique, can be detected.

Thus, the lane marks can be reliably detected even though the captured image contains a shadow (bridge shadow 88) of the overpass (bridge), crossing a part of the road surface 62, or contains a shadow of a tall building, for example.

Preferably, the ECU 20 that serves as the lane mark detection unit divides the captured image 60 into the plurality of blocks blk each adjacent to each other in the vertical direction and extending in the horizontal direction, then further divides the blocks blk into left and right blocks (B1a to B9a, B1b to B9b), and then calculates a mean brightness Bmean for each of the blocks. The blocks B1a to B9a constitute the block Bβa, and the blocks B1b to B9b constitute the block Bβb.

When the sun is directly above a road, the bridge shadow 88 is formed like a strip in a horizontal direction, in the image 60 showing the road surface 62 on which the lane marks 70 and 80 are formed. But when the sun is either on the left side or on the right side with respect to the road, the bridge shadow 88 is often formed like a strip in a direction oblique to the horizontal direction. In the latter case, a mean brightness Bmean of a left block and a mean brightness Bmean of a right block in the image 60 become different to each other, which can cause a failure of detection of some lane marks. As a countermeasure of this, the image 60 is first divided into the plurality of blocks folk each adjacent to each other in the vertical direction and extending in the horizontal direction, and is then further divided into the left and right blocks (Bβa, Bβb) using the center line 65 (FIG. 7) extending upward from the origin O. The mean brightness Bmean is then calculated for each of the divided blocks folk, which allows the detection of a lane mark, such as the lane mark 72a (FIGS. 6 and 8), which cannot be detected with a conventional technique.

The mean brightness Bmean of the plurality of blocks blk each extending in the horizontal direction may be calculated sequentially from the lower block to the upper block. Accordingly, when the bridge shadow 88 is formed in a strip in a horizontal direction and in a middle portion of the image 60, for example, the above calculation can determine the blocks in the order of the bright block blkw, the dark block blkb, and the bright block blkw, from the lower side of the image 60, which allows a stable lane mark detection.

The binarization threshold Th may also be set, in the order of the bright block blkw, the dark block blkb, and the bright block blkw, from the lower side of the image 60, as the binarization threshold Thw of the bright block blkw, the binarization threshold Thb of the dark block blkb smaller than the binarization threshold Thw of the bright block blkw (Thb<Thw), and the binarization threshold Thw of the. bright block blkw. This allows easy and appropriate setting of the binarization thresholds Thw and Thb of the bright block blkw and the dark block blkb.

Further, the display 28 may be provided for indicating that the lane marks 70 and 80 are being detected by the ECU 20 that serves as the lane detection unit when the ECU 20 is detecting the lane marks 70 and 80. With the display indicating that the lane marks 70 and 80 are being detected on the display 28, vehicle occupants can visually recognize a normal detection of the lane that is performed by the lane detection device 10 of the vehicle 12.

The display 28 (FIG. 3), which may be a headup display, may show a lane-like display 92 created to imitate lane marks. This allows a driver to recognize a normal detection of the lane, thus assisting driving.

As a matter of course, the present application is not limited to the above embodiments, and covers various modifications based on the description herein.

What is claimed is:

1. A lane detection device comprising:
an image capturing device that is installed in a vehicle and captures a forward view image of a road surface from the vehicle, the image having a vertical direction along a traveling direction of the vehicle; and
a lane mark detection unit that performs binarization of the forward view image captured by the image capturing device, using a binarization threshold, and detects lane marks in the forward view image of the road surface, wherein
the lane mark detection unit configured to,
divide the captured forward view image into a plurality of blocks adjacent to one another in the vertical direction and each extending in a horizontal direction,
detect a brightness of each of the plurality of blocks and determine whether each of the plurality of blocks is a bright block or a dark block, the bright block having a brightness that is higher than a brightness of the dark block, and
change the binarization threshold depending on whether the block is the bright block or the dark block, thereby applying the binarization threshold that is different between the bright block and the dark block in the binarization of the captured, forward view image.

2. The lane detection device according to claim 1, wherein
the lane mark detection unit determines the binarization threshold for the dark block to be smaller than the binarization threshold for the bright block in the binarization of the captured forward view image.

3. The lane detection device according to claim 1, wherein after dividing the captured forward view image into the plurality of blocks adjacent to one another in the vertical direction and each extending in the horizontal direction, the lane mark detection unit further divides the blocks into left and right blocks, and calculates a mean brightness for each of the left and right blocks.

4. The lane detection device according to claim 1, wherein the mean brightness is calculated sequentially from a lower side to an upper side of the blocks in the vertical direction.

5. The lane detection device according to claim 4, wherein the binarization threshold is determined in the order of the bright block, the dark block, and the bright block, from the lower side of the forward view image, which is the order of the binarization threshold for the bright block, the binarization threshold for the dark block smaller than the binarization threshold for the bright block, and the binarization threshold for the bright block.

6. A lane display device comprising:
the lane detection device according to claim 1; and
a display that indicates that lane marks are being detected by the lane mark detection unit when the lane mark detection unit is detecting the lane marks.

7. The lane display device according to claim 6, wherein the display is a headup display that shows a virtual lane marks.

8. A lane detection method for performing binarization of a captured forward view image of a road surface in front of a vehicle, the image having a vertical direction along a traveling direction of the vehicle, the method comprising:
a block brightness calculation step of dividing the forward view image into a plurality of blocks adjacent to one another in the vertical direction and each extending in a horizontal direction, and calculating a mean brightness for each of the blocks;
a bright and dark block determination step of determining whether each of the plurality of blocks is a bright block or a dark block, based on the mean brightness of each of the blocks;
a threshold determination step of determining a binarization threshold for each block such that the binarization threshold for dark block is smaller than the binarization threshold for the bright block; and
a lane mark detection step of performing binarization of the captured forward view image by using the binarization thresholds and detecting lane marks.

9. A lane display method further comprising:
a display step of displaying, on a front window of the vehicle, virtual lane marks detected by the lane detection method according to claim 8.
